(19) United States
(12) Patent Application Publication
(10) Pub. No.: US 2008/0216910 A1
(43) Pub. Date: Sep. 11, 2008

(54) QUICK CONNECT PRESSURE TEST CAP MOUNTED ON A STUBOUT TUBE

(76) Inventors: William Franklin Turnau, Canton, MI (US); Ronald D. Green, New Hudson, MI (US); Derry Yourman, Livonia, MI (US); Kurt Klimkiewicz, Dearborn, MI (US); Hyun Moon, Bloomfield Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/044,024

(22) Filed: Mar. 7, 2008

Related U.S. Application Data
(60) Provisional application No. 60/905,689, filed on Mar. 8, 2007.

(51) Int. Cl. F16L 55/115; F16L 37/60; F16L 37/00

(52) U.S. Cl. 138/89; 138/96 R; 285/148.21; 285/148.2

(57) ABSTRACT

A pressure cap assembly snaps onto a stubout tube in a plumbing supply system through a quick connect coupling. The pressure cap assembly may include two parts, with the first part snap fitting to the stubout tube and a second part snap fitting to the first part.

### RELATED APPLICATIONS

The application claims priority to U.S. Provisional Application No. 60/905,689 which was filed on Mar. 8, 2007.

### BACKGROUND OF THE INVENTION

This application relates to a pressure test cap which can be attached to a stubout tube in a water supply system through a quick connect coupling.

Water supply systems typically are provided with a stubout tube that extends through a wall of a building. Various fluid connections are then made to the stubout tube, such as to deliver water to a faucet, etc.

During rough installation of this plumbing system, the integrity of the roughed in plumbing must be tested. Ends of the stubout tubes must be capped to perform this testing.

In the past, a special cap has been installed on each stubout, then removed for final installation of the plumbing fixtures. This practice can be quite labor intensive.

More recently, the stubout tubes have been provided with quick connect fluid couplings for the connection to the plumbing fixtures. The stubout tubes have been provided with an annular groove in the outer surface to receive the quick connect couplings.

### SUMMARY OF THE INVENTION

In the disclosed embodiment of this invention, a pressure cap is connected to a stubout tube through a quick connect coupling. In an embodiment, the pressure cap includes at least two housing portions, with a cap housing and a cap body. The cap housing includes an inner shoulder which is received in the annular groove, and the cap body snaps to the cap housing. An intermediate seal may be positioned between these two portions to complete the seal. The three components may be preassembled and then attached to a stubout tube.

These and other features of the present invention can be best understood from the following specification and drawings, the following of which is a brief description.

### BRIEF DESCRIPTION OF THE DRAWINGS

FIG. 1 shows an assembled pressure test cap and stubout.

FIG. 2 is a cross-sectional view of the pressure test cap.

FIG. 3 is an exploded view of the pressure test cap.

FIG. 4 shows a first step in removing the pressure test cap.

FIG. 5 shows a subsequent step in the removal.

FIG. 6 shows yet another step.

FIG. 7 shows yet another step.

FIG. 8 shows a final step.

### DETAILED DESCRIPTION OF THE PREFERRED EMBODIMENT

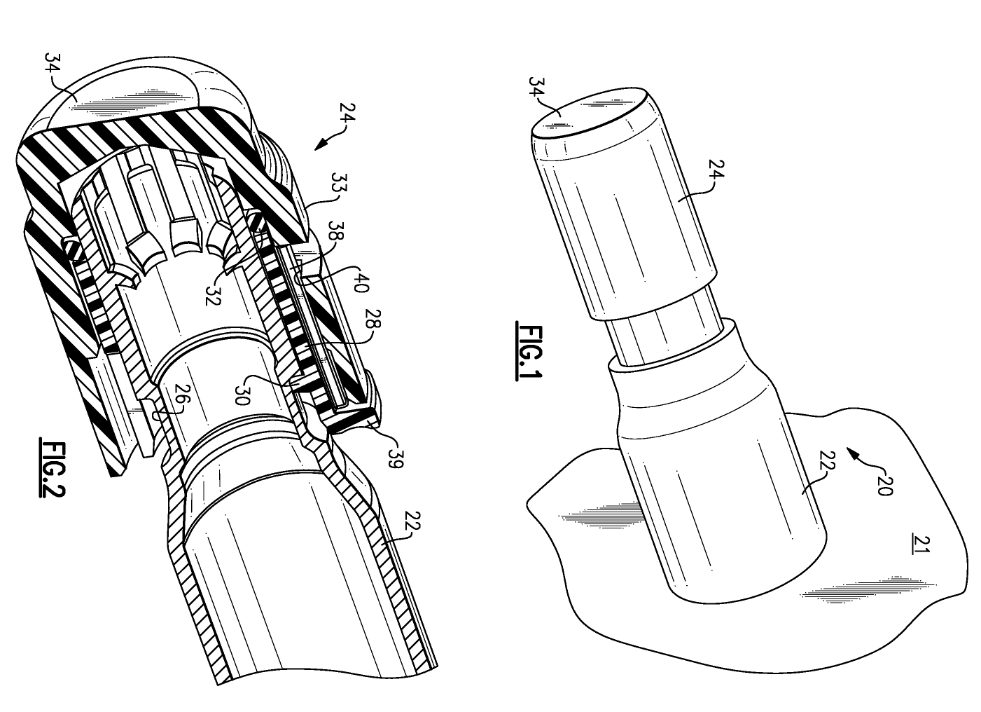

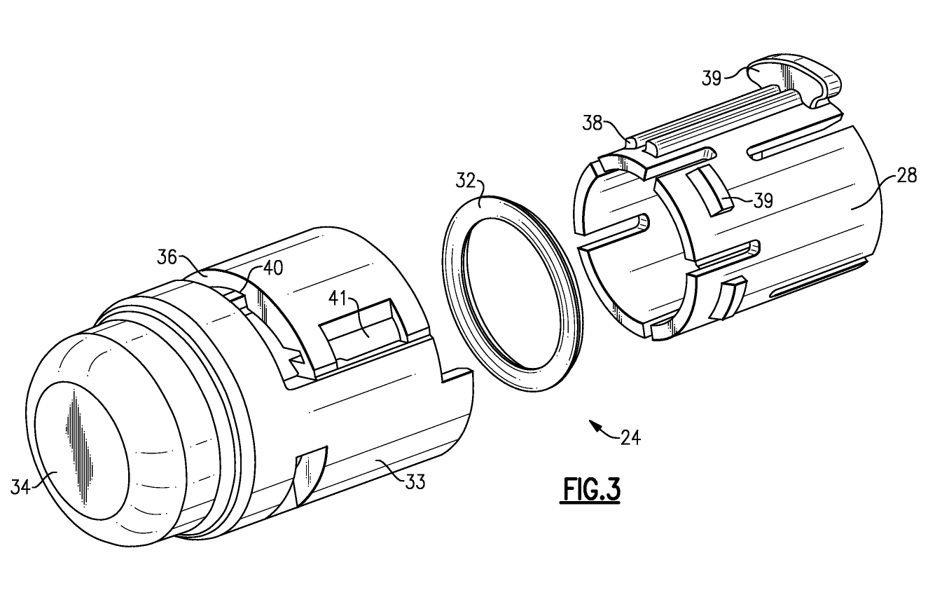

FIG. 1 shows a wall 21 having an extending stubout tube 22 as part of a plumbing assembly 20. As is known, during rough construction, a pressure test must be provided on an overall plumbing assembly and thus a cap must be placed on the stubout tube. In FIG. 2, the inventive cap 24 is shown having an end 34 that closes off the stubout tube 22.

As shown in FIG. 2, the pressure test cap includes a cap housing 28 having a radially inwardly extending barb 30 which snaps into a groove 26 in the outer periphery of the stubout tube 22. A second housing portion 33 snaps onto the cap housing 28, as will be explained with regard to FIG. 3. A seal 32 is captured between the stubout tube 22 and the housing 33.

In practice, the cap housing 28 is assembled with the seal 32 and the second housing portion 33, and shipped as a preassembled unit. Then, the preassembled unit may be snapped on to a stubout tube.

As can be appreciated from FIG. 3, the cap housing 28 has radially outwardly extending barbs 38 that are received within a groove 40 in the second housing portion 33 to prevent relative rotation. This can be seen in FIG. 2 also.

An opening 36 in the second housing portion 33 receives barbs 39, to secure the two housing portions together.

A slot 41 will assist in removing the pressure test cap, as will be explained below. A thumb portion 39 is also provided to assist in removal.

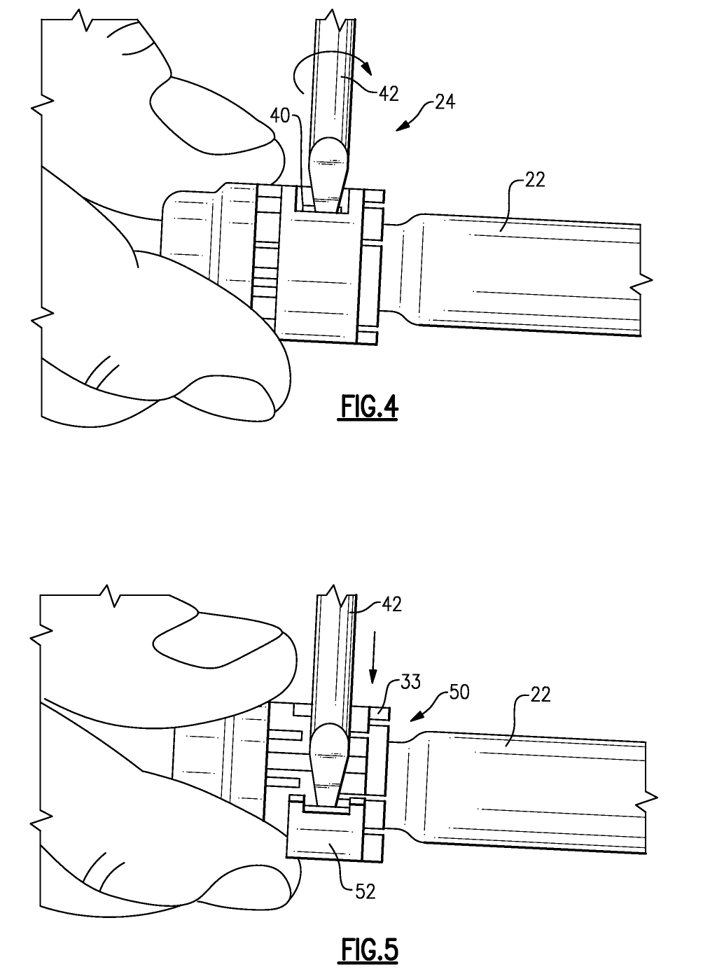

As can be appreciated from FIGS. 4-8, an initial step of removing the pressure test cap is to insert a screwdriver 42 into the slot 41. The screwdriver can then be pivoted or turned to crack the second housing portion 33, and as shown at 50 in FIG. 5, with a portion 52 moving away from the stubout tube 22, as the second housing portion 33 breaks.

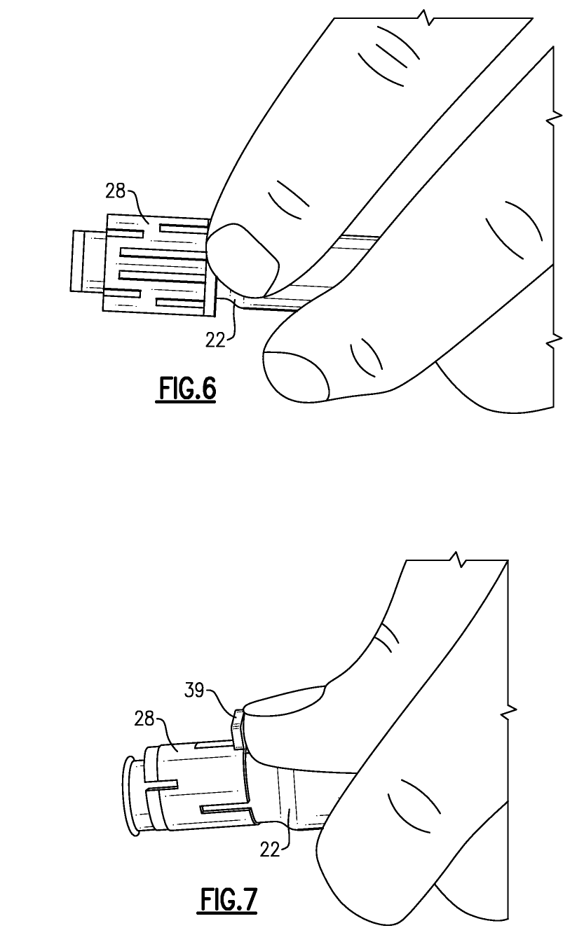

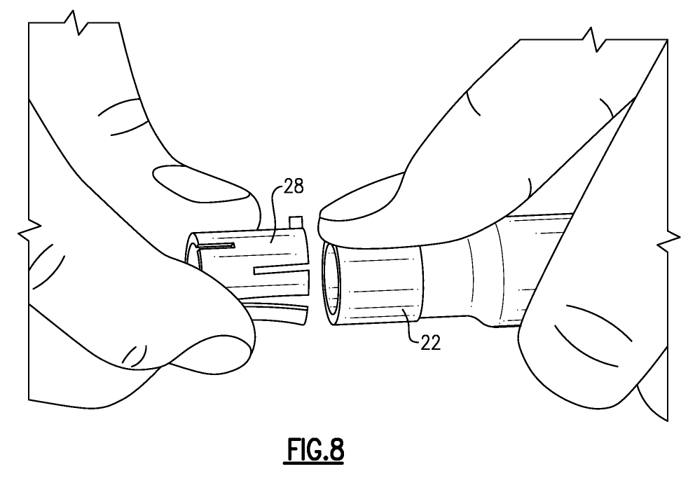

As shown in FIG. 6, this then leaves the cap housing 28. The cap housing 28 is removed by applying force on the thumb portion 39 to pivot the barb 38 outwardly of the recess 26. The cap housing is then removed as can be appreciated from FIG. 8.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A pressure cap for a stubout tube comprising:
a pressure cap assembly having a closed end and a bore to be received on a stubout, said closed end closing off the stubout tube such that a pressure test can occur; and
said pressure cap assembly having a quick connect structure such that it can snap onto a stubout tube.

2. The pressure cap as set forth in claim 1, wherein a radially inwardly extending barb on said pressure cap assembly is for snapping into a groove in an outer periphery of the stubout tube.

3. The pressure cap as set forth in claim 1, wherein said pressure cap assembly includes two housing parts, with a first housing part having a snap end connection to snap onto a stubout tube, and a second housing part snapping onto said first housing part.

4. The pressure cap as set forth in claim 3, wherein one of said first and second housing parts has a radially extending shoulder, and the other has a groove, with said shoulder snapping into said groove.

5. The pressure cap as set forth in claim 4, wherein said second housing part has the groove and said shoulder on said first housing part snaps into said groove.

6. The pressure cap as set forth in claim 4, wherein said groove and said shoulder extend over only a limited circumferential extent.

7. The pressure cap as set forth in claim 3, wherein a seal is received between said first and second housing parts.

8. The pressure cap as set forth in claim 3, wherein one of said first and second housing parts has a barb which extends into a groove on the other of said first and second housing parts to prevent relative rotation.

9. The pressure cap as set forth in claim 8, wherein the barb is formed on said first housing part, and extends into the groove in said second housing part.

10. The pressure cap as set forth in claim 1, wherein a slot is provided to assist in removing the pressure cap from a stubout tube.

11. A system comprising:
a stubout tube;
a pressure cap assembly having a closed end and a bore to be received on the stubout tube, said closed end closing off the stubout tube such that a pressure test can occur; and
said pressure cap assembly having a quick connect structure that is snapped onto the stubout tube.

12. The system as set forth in claim 11, wherein a radially inwardly extending barb on said pressure cap assembly snaps into a groove in an outer periphery of the stubout tube

13. The system as set forth in claim 11, wherein said pressure cap assembly includes two housing parts, with a first housing part having a snap end connection snapped onto the stubout tube, and a second housing part snapped onto said first housing part.

14. The system as set forth in claim 13, wherein one of said first and second housing parts has a radially extending shoulder, and the other has a groove, with said shoulder snapped into said groove.

15. The system as set forth in claim 14, wherein said second housing part has the groove and said shoulder snaps on said first housing part is snapped into said groove.

16. The system as set forth in claim 15, wherein said groove and said shoulder extend over only a limited circumferential extent.

17. The system as set forth in claim 13, wherein a seal is received between said first and second housing parts.

18. The system as set forth in claim 13, wherein one of said first and second housing parts has a barb which extends into a groove on the other of said first and second housing parts to prevent relative rotation.

19. The system as set forth in claim 18, wherein the barb is formed on said first housing part, and extends into the groove in said second housing part.

20. The system as set forth in claim 11, wherein a slot is provided to assist in removing the pressure cap from a stubout tube.
